(19) United States
(12) Patent Application Publication
(10) Pub. No.: US 2007/0022574 A1
(43) Pub. Date: Feb. 1, 2007

(54) V-channel clamp

(76) Inventors: John I. Belisle, Hampton, MN (US); Allan T. Hovda, Savage, MN (US); Josh Kundert, Burnsville, MN (US)

Correspondence Address: MERCHANT & GOULD PC, P.O. BOX 2903, MINNEAPOLIS, MN, 55402-0903, US

(21) Appl. No.: 11/454,306

(22) Filed: Jun. 15, 2006

Related U.S. Application Data
(60) Provisional application No. 60/691,505, filed on Jun. 16, 2005.
(60) Provisional application No. 60/734,740, filed on Nov. 7, 2005.

(51) Int. Cl. F16L 23/00

(52) U.S. Cl. 24/19; 285/407

(57) ABSTRACT

The present disclosure relates to a clamp including a channel structure having a generally v-shaped cross-section. Notches can be provided through the channel structure to enhance flexibility. A sleeve and bolt fastening arrangement can be used to tighten the clamp.

This application claims the benefit of U.S. Provisional Patent Application Ser. No. 60/691,505, filed Jun. 16, 2005 and U.S. Provisional Patent Application Ser. No. 60/734,740, filed Nov. 7, 2005, which applications are hereby incorporated by reference in their entirety.

### TECHNICAL FIELD

The principles disclosed herein relate to clamps for coupling flanged conduits such as pipes or ducts. More particularly, the disclosure relates to clamps including channels having V-shaped cross-sections.

### BACKGROUND OF THE INVENTION

FIG. 1 illustrates a prior art V-band clamp 20 for coupling flanged conduits. The clamp 20 includes an outer strap 22 having first and second looped ends 24 and 26. First and second trunions 28, 30 are respectively mounted within the first and second looped ends 24, 26. The first trunion 28 defines an internally threaded opening, and the second trunion 30 defines a clearance opening. The first and second looped ends 24, 26 are fastened together by a bolt 32 that traverses a gap 34 between the looped ends 24, 26. The bolt 32 passes through the clearance opening of the second trunion 30 and is threaded into the internally threaded opening of the first trunion 28. The clamp 20 is tightened by threading the bolt 32 into the first trunion 28 such that the gap 34 closes.

The clamp 20 also includes three channel members 36 secured to the inner side of the strap 22. Each of the channel members 36 defines a generally V-shaped channel 38 (see FIG. 2) that opens inwardly toward the center of the clamp. The channels 38 provide a means for receiving the flanges of a pair of flanged conduits desired to be coupled together.

FIG. 2 shows the clamp 20 being used to clamp a first conduit 40 to a second conduit 42. The conduits 40, 42 respectively include flanges 44, 46. To clamp the conduits 40, 42 together, the flanges 44, 46 are placed in an abutting end-to-end relationship to form a joint, and the clamp 20 is then mounted over the joint with the abutting flanges 44, 46 inserted within the channels 38 of the channel members 36. By tightening the bolt 32, the clamp 20 draws the flanges 44, 46 together to provide a secure connection between the conduits 40, 42.

Ideally, V-band clamps of the type described above provide an effective seal between the flange end faces of two conduits being clamped together. However, for a number of reasons, clamps of the type described above often fail to provide an adequate seal between two flanged conduits. Reasons for such failures include non-uniform clamping forces about the circumferences of the flanges, inadequate clamping forces, and the inability of clamps to effectively conform to irregularities in the shapes of the flanges.

### SUMMARY

One inventive aspect of the disclosure relates to conduit clamps having structures adapted for providing a more uniform clamping force around the circumference of flanged conduits being clamped together as compared to prior art style V-band clamps.

Another inventive aspect of the disclosure relates to conduit clamps adapted to conform to variations in flange shape provide improved sealing performance.

A further inventive aspect of the disclosure relates to conduit clamps and to clamping systems having enhanced sealing capabilities.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is an end view of a prior art clamp being used to interconnect two flanged pipes;

FIG. 2 is a cross-sectional view taken along section line 2-2 of FIG. 1;

FIG. 3 is a front view of a clamp having features that are examples of inventive aspects in accordance with the principles of the present disclosure;

FIG. 4 is a cross-sectional view taken along section line 4-4 of FIG. 3;

FIG. 5 is a cross-sectional view taken along section line 5-5 of FIG. 3;

FIG. 6 is a front view of one of the channel segments of the clamp of FIG. 3;

FIG. 7 is a right side view of the channel segment of FIG. 6;

FIG. 8 is a plan view of the channel segment of FIG. 6 with the channel section laid flat prior to the channel being formed therein;

FIG. 9 is a front view of an alternative channel segment in accordance with the principles of the present disclosure;

FIG. 10 is a right side view of the channel segment of FIG. 9;

FIG. 11 is a cross-sectional view taken along section line 11-11 of FIG. 9;

FIG. 12 is a plan view of the channel segment of FIG. 9 with the channel section laid flat prior to the channel being formed therein;

FIG. 13 is a front view of another clamp having features that are examples of inventive aspects in accordance with the principles of the present disclosure;

FIG. 14 is a cross-sectional view taken along section line 14-14 of FIG. 13;

FIG. 15 is a cross-sectional view taken along section line 15-15 of FIG. 13;

FIG. 16 is a front view of one of the channel segments of the clamp of FIG. 13;

FIG. 17 is a front view of a further clamp having features that are examples of inventive aspects in accordance with the principles of the present disclosure;

FIG. 18 is a left side view of the clamp of FIG. 17;

FIG. 19 is a bottom view of the clamp of FIG. 17;

FIG. 20 is a cross sectional view taken along section line 20-20 of FIG. 17;

FIG. 21 is a cross sectional view taken along section line 21-21 of FIG. 17;

FIG. 22 is a cross sectional view taken along section line 22-22 of FIG. 17;

FIG. 23 is a cross sectional view taken along section line 23-23 of FIG. 17; and

FIG. 24 is a front view of still another clamp having features that are examples of inventive aspects in accordance with the principles of the present disclosure.

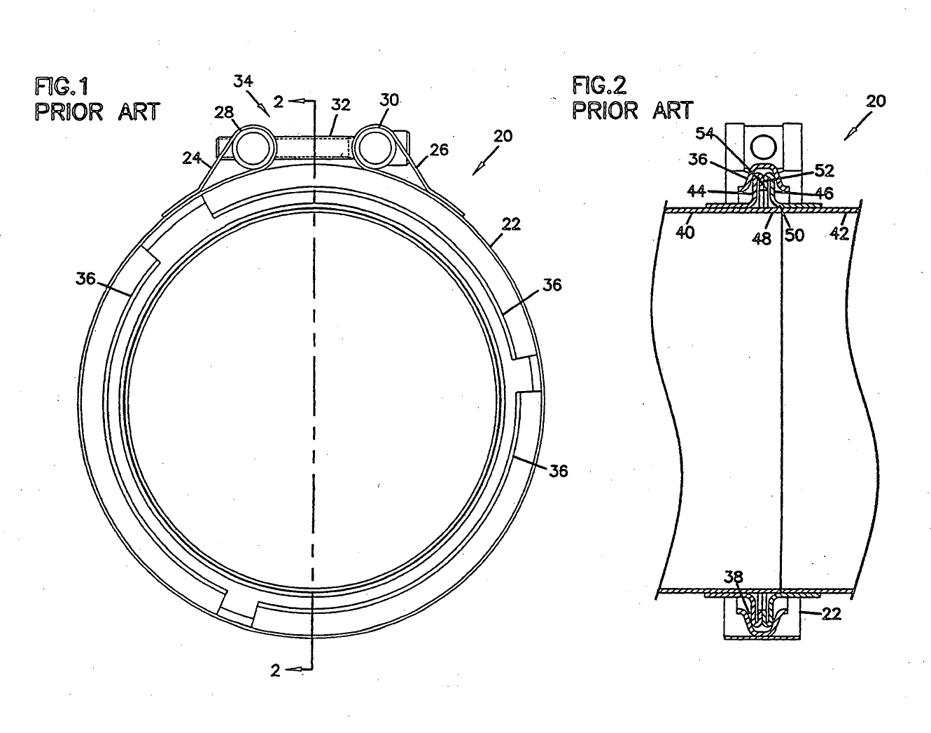

### DETAILED DESCRIPTION

Clamps in accordance with the principles of the present disclosure can be used to connect flanged conduits together. In certain embodiments, the conduits can be pipes such as exhaust pipes. In other embodiments, the conduits can be canisters or housings (e.g., muffler bodies) for holding exhaust aftertreatment devices such as catalytic converters, diesel particulate filters or other devices. Example aftertreatment devices and flange configurations are disclosed in U.S. provisional application Ser. Nos. 60/636,459; 60/662,904; and 60/678,870 that are incorporated herewith by reference in their entireties.

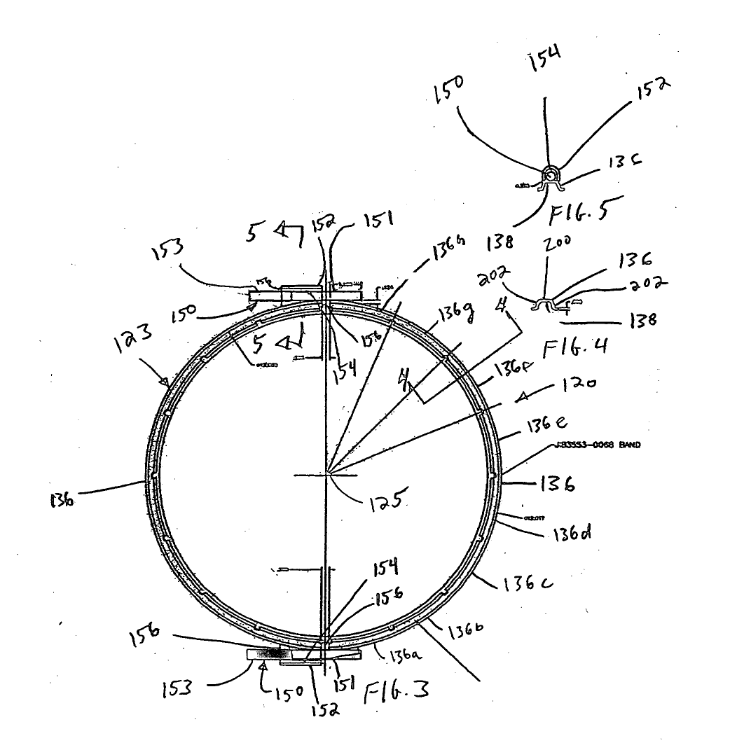

FIGS. 3-5 illustrate a clamp 120 having features that are examples of inventive aspects in accordance with the principles of the present disclosure. The clamp 120 includes a band structure 123 that encircles a center reference point 125. The band structure 123 includes two channel segments 136. In the depicted embodiment, the channel segments 136 are half-circles with interior sides opposing one another to generally form a circular band. The channel segments 136 each define a flange engagement channel 138 (e.g., generally V-shaped channels as shown in FIGS. 4 and 5) adapted to receive the flanges (e.g., like flanges 44, 46 of FIG. 2) of two abutting flanged conduits desired to be joined together. Fasteners such as bolts 150 are secured (e.g., welded) to opposite ends of one of the channel segments 136. The bolts 150 have base ends 151 secured to the outer surface of the channel segment 136 and free ends 153 that are threaded. The bolts 150 are generally tangentially aligned relative to the outer surface of the channel segment 136. Sleeves 152 (i.e., tunnels) are secured (e.g., welded) to opposite ends of the other channel segment 136. As shown at FIG. 3, the sleeves 152 define passages 154 through which the bolts 150 extend. Gaps 156 are defined between the ends of the channel segments 136. The clamp 120 is tightened by threading nuts on the threaded ends 153 of the bolts 150. As the nuts are threaded on the bolts 150, the nuts and engage end surfaces 156 of the sleeves 152 causing the channel segments 136 to be drawn together. As the channel segments 136 are drawn together, the gaps 156 close and the clamp is tightened.

By using two or more bolts 150 circumferentially separated from one another, the clamp 120 effectively distributes clamping force evenly along the channel segments 136. The use of multiple fasteners also allows higher clamping forces to be generated than single fastener clamps. High clamping forces and effective clamping force distribution makes it easier to achieve leak free or reduced-leakage joints. These factors also assist in withstanding environmental forces, such as shock, vibration and thermal cycling, which are encountered when holding heavy exhaust aftertreatment devices together.

In the embodiments of FIG. 3, two sleeves are provided on one of the channel segments and two bolts are provided on the other channel segment. This is advantageous because both bolts can be accessed from the same side of the clamp. However, in other embodiments, a bolt can be secured at one end of each channel section and a sleeve can be secured at the other end of each channel segment. This would promote manufacturing efficiency because both pieces of the clamp would have the same configuration. In still other embodiments, the channel segments can be reinforced along their entire lengths by U-bolt sections secured to the exterior of the channel segments.

The channel segments 136 can be pressed, formed, stamped rolled or otherwise made from a flat band of material. Example material for manufacturing the channel segments 136 include steel, stainless steel, or other materials. In certain embodiments, the band can have a thickness t in the range of 0.05-0.25 inches. In other embodiments, the band can have a thickness t in the range of 0.07-0.125 inches. In still other embodiments, the band can have a thickness of about 0.098 inches.

Referring to FIG. 4, the channel segments 136 can have transverse cross-sections that define generally V-shaped channels 138. As shown at FIG. 4, the channel segments 136 include base portions 200 and legs 202 that project inwardly from the base portions 200. The legs 202 diverge as the legs extend away from the base portion 200 to generate the V-shaped channel. While V-shaped channels are preferred, other channel shapes could also be used.

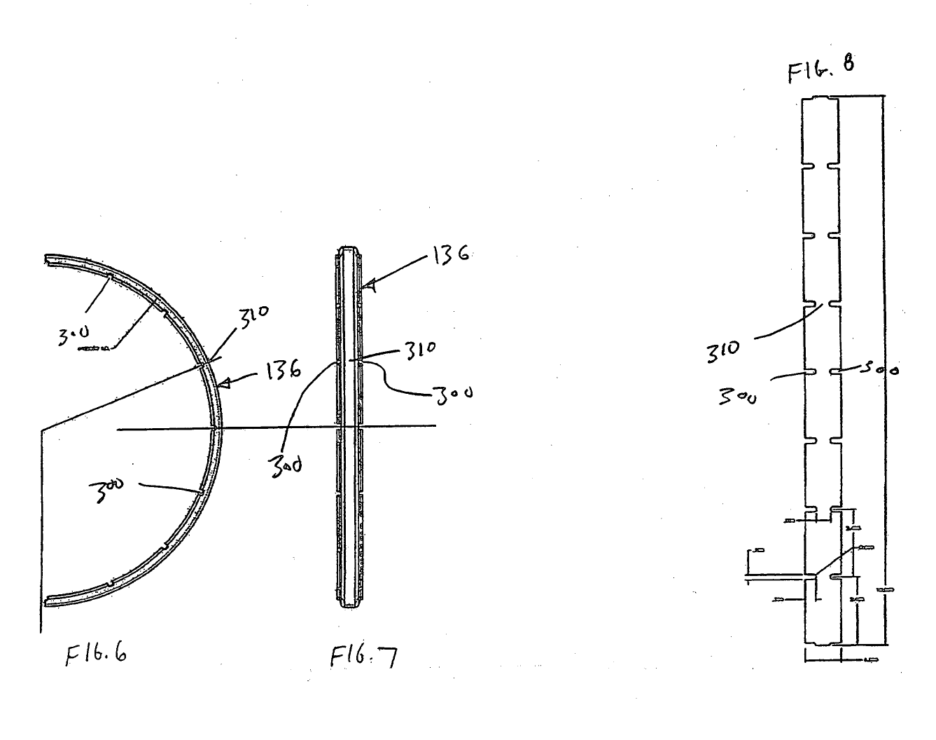

Referring to FIGS. 6-9, the channel segments 136 each define a plurality of notches 300 for increasing the flexibility of the segments 136, and for allowing the segments 136 to better conform to shape irregularities in the flanges being clamped. In a preferred embodiment, the notches 300 cut completely through the legs 202 to the base portions 200. In this way, a plurality of separate clamping members 136a-h are provided at each channel segment 136. The notches 300 allow the clamping members to independently grip and conform to relatively short sections of flange. In this way, adjacent clamping members generally do not influence one another thereby allowing the clamp to better accommodate localized size variations in the flanges being clamped. In one embodiment, at least 3 separate clamping members are provided per channel segment. In another embodiment, at least 4 separate clamping members are provided per channel segment. In still another embodiment, at least 5 separate clamping members are provided per channel segment. In the depicted embodiment, 8 clamping members are provided per channel segment.

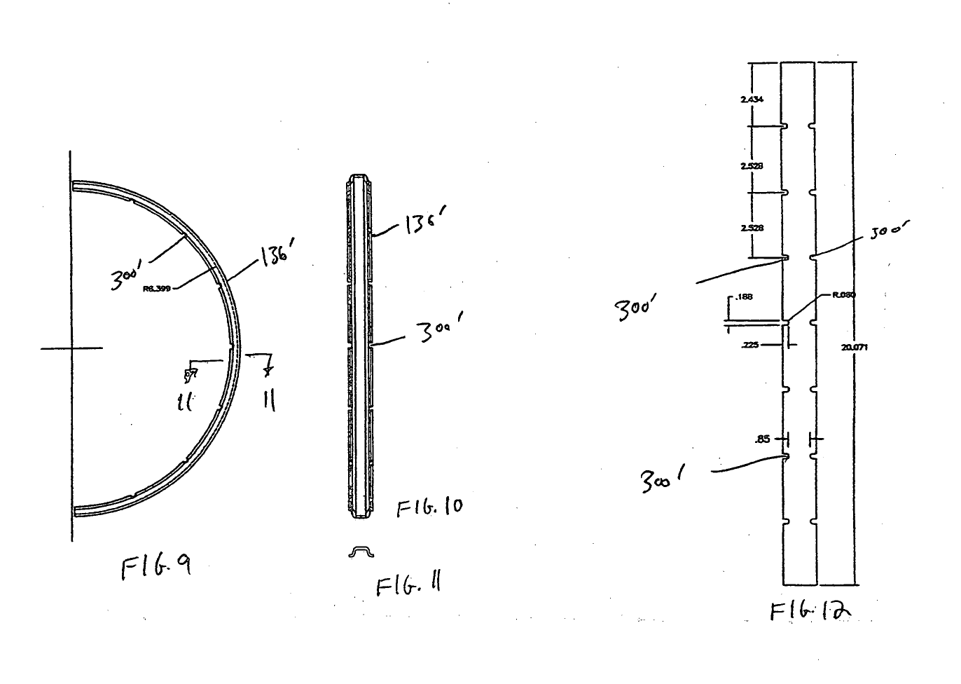

While it is preferred for the notches to be sized to provide independent gripping members on each channel segment, smaller notches can also be used. For example, FIGS. 9-12 show a channel segment 136′ having notches 300′ that do not extend completely through the legs of the channel segments.

Referring again to FIGS. 6-8, the notches 300 define flex regions 310 positioned between each of the separate clamping members 136a-h. The flex regions 310 allow the clamp to flex to better conform to the shape of the flanges being clamped. In one embodiment, the bolts 150 and the channels segments 136 are made of stainless steel, the flex regions 310 have cross-sectional areas of at least 20 percent the cross-sectional are of each bolt. In other embodiments, the flex regions have cross-sectional areas of at least 30, 40, 50, 60, 70 or 80 percent of the cross-sectional area of each bolt. Preferably, the flex regions have sufficient cross-sectional area to prevent failure during normal use. In certain embodiments, the cross-sectional areas of the flex regions 310 can be designed to allow slight stretching of the flex regions as the clamp 120 is tightened.

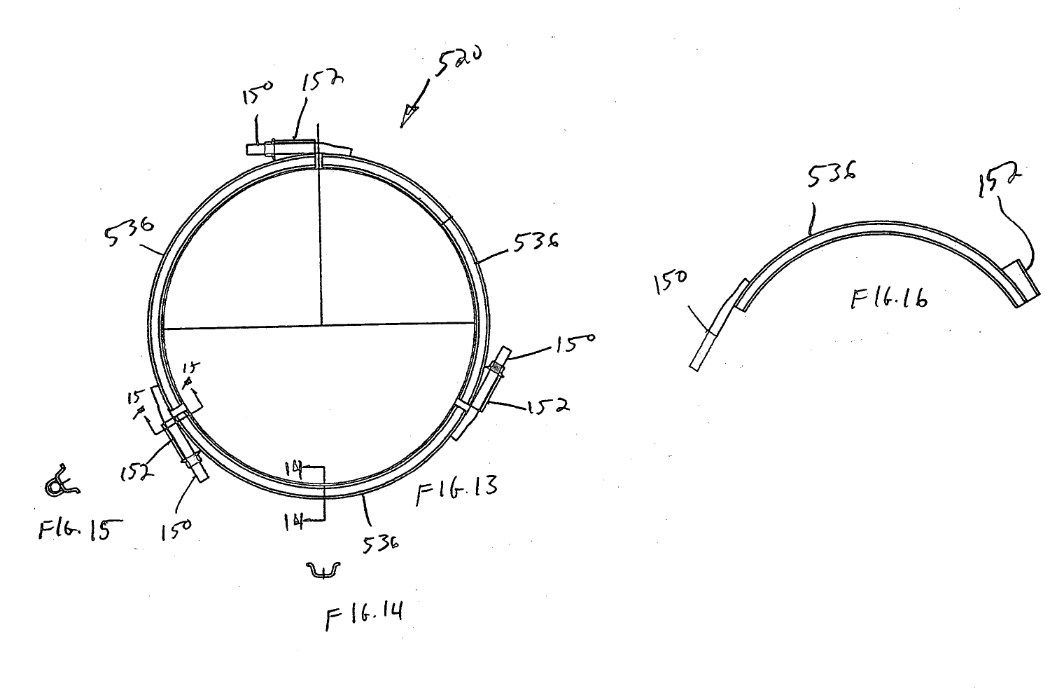

FIGS. 13-16 show an alternative clamp 520 in accordance with the principles of the present disclosure. The clamp 520 includes 3 channel segments 536 that cooperate to defined a circular band structure. A bolt 150 and a sleeve 152 are secured to the ends of each channel segment 536. The channel segments 536 are not notched.

Vehicle exhaust systems can often include heat shields that surround certain components of the systems to prevent relatively hot components from being exposed. For example, heat shields are often provided around the exterior of vertical mufflers on trucks. An example heat shield around a vertical muffler can be spaced about 1 inch from the vertical muffler and often wraps around ½to ¾of the circumference of the muffler. Heat shields can make it difficult to access clamps positioned beneath the shields.

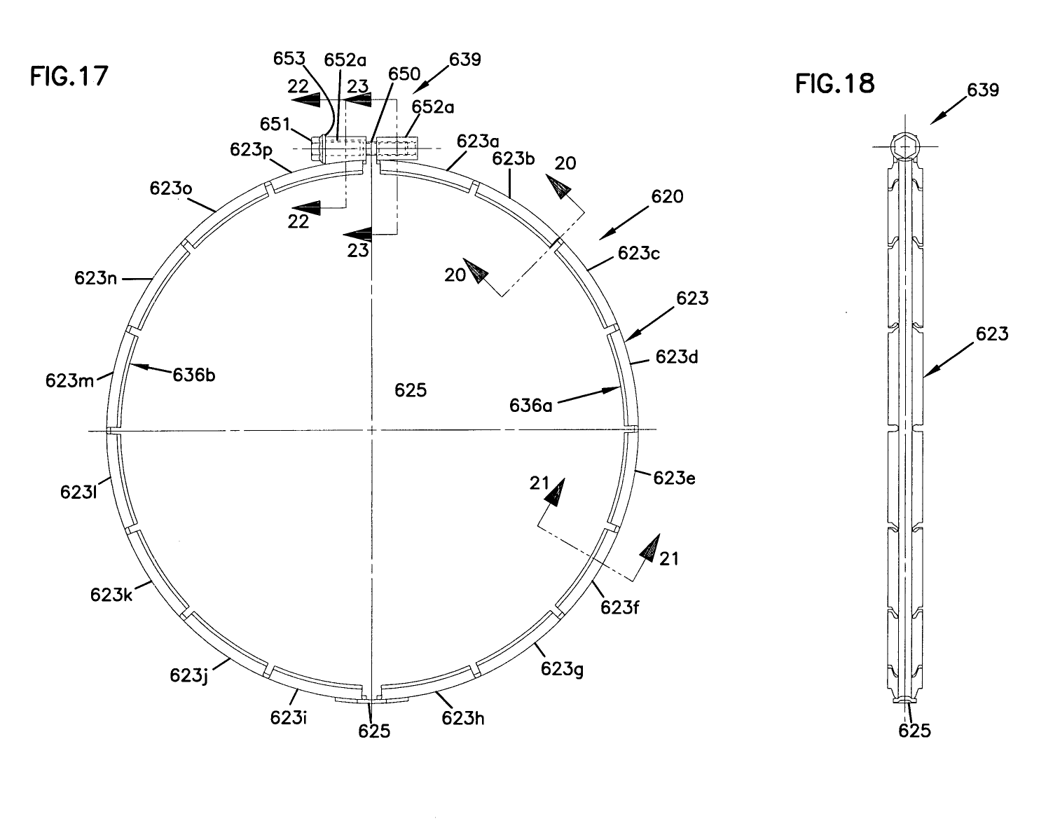

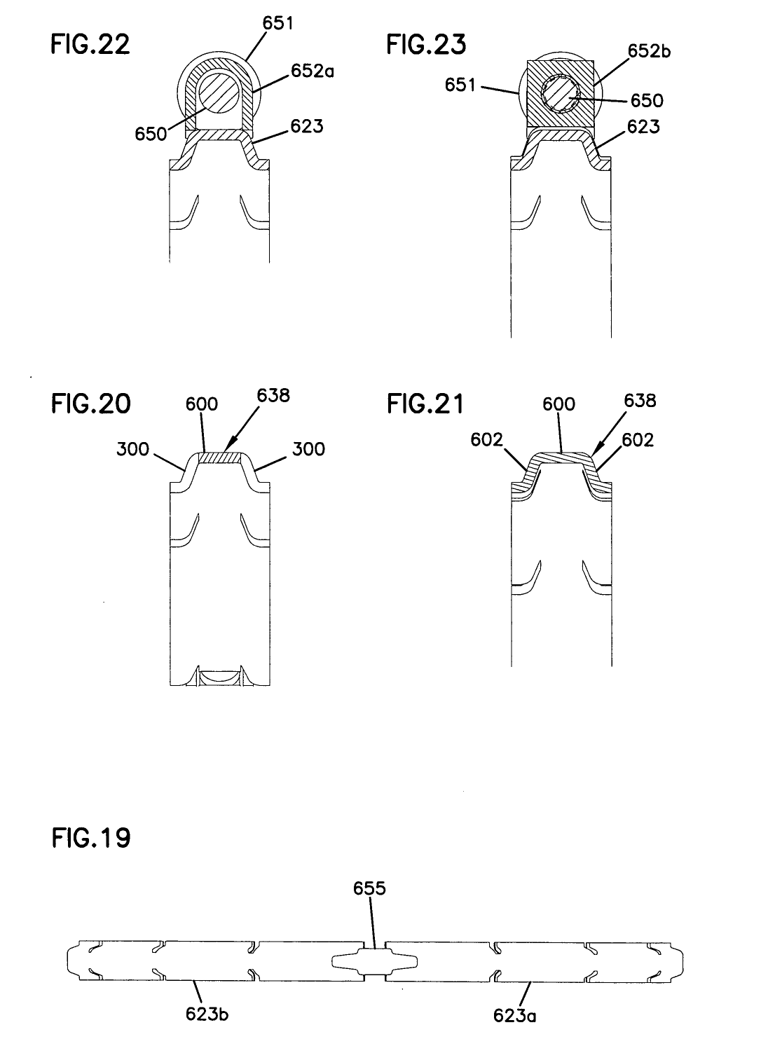

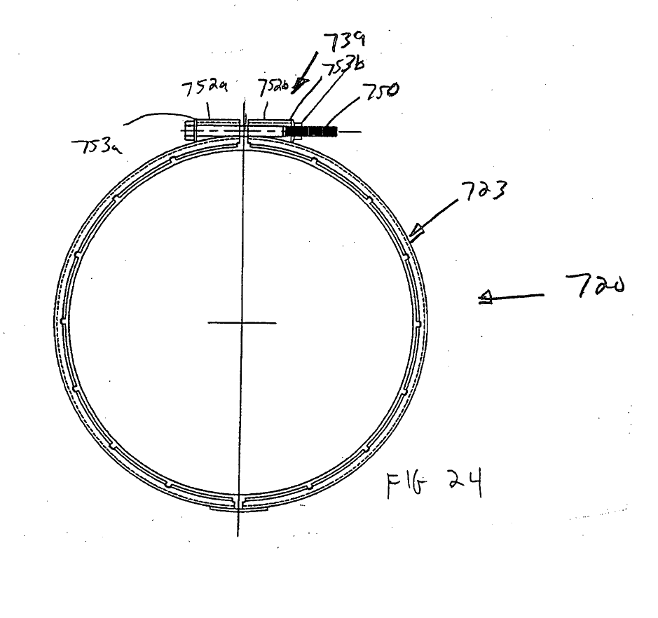

FIGS. 17-22 illustrate a further clamp 620 having features that are examples of inventive aspects in accordance with the principles of the present disclosure. The clamp 620 includes a band structure 623 that encircles a center reference point 625. The band structure 623 defines a flange engagement channel 638 (e.g., a generally v-shaped channel as shown at FIG. 21) adapted to receive the flanges of two abutting flanged conduits desired to be joined together. The clamp 620 includes a fastening arrangement 639 for tightening (i.e., constricting the diameter of the band structure 623) and/or loosening (i.e., enlarging the diameter of the band structure 623) the clamp 620. The fastening arrangement 639 is positioned at a single circumferential location of the clamp 620. By having a single fastening arrangement located at a single circumferential position of the clamp, the fastening arrangement can be readily positioned at the uncovered portion of a shielded exhaust system component. For example, when the clamp 620 is used to interconnect two portions of a shielded vertical muffler, the band structure 623 extends between the shield and the vertical muffler, and the fastening arrangement 639 is located at the gap between the ends of the shield. By positioning the fastening arrangement 639 at the gap between the ends of the shield, the fastening arrangement can be readily accessed to loosen, tighten, remove, install or otherwise access the clamp.

The fastening arrangement 639 includes a first sleeve 652a secured to one end of the band structure 623, and a second sleeve 652b secured to the other end of the band structure 623. The first sleeve 652a defines a non-threaded internal opening sized for slidably receiving a fastener such as a bolt 650. The sleeve 652b is internally threaded with threading that matches the threading of the bolt 650. When the clamp 620 is assembled, the openings of the first and second sleeves 652a, 652b are generally coaxially aligned. By inserting the bolt 650 through the first sleeve 652a, and threading the bolt into the second sleeve 652b, the ends of the band structure 623 can be drawn together to tighten the clamp 620. By turning the bolt 650 in the opposite direction, the bolt unthreads from the second sleeve 652b causing the gap between the ends of the band structure 623 to enlarge and the clamp to loosen. The bolt 650 is shown including a head 651 that seats upon a seating surface 653 of the first sleeve 652a.

Referring to FIG. 17, the band structure 623 includes a plurality of pairs of notches 300 for dividing the band structure 623 into a plurality of separate clamping members 623a-623p. The clamping members 623a-623p operate similar to those previously described in the embodiments of FIGS. 6-9. In certain embodiments, the band structure 623 includes at least 6, 8, 10, 12, 14 or 16 separate clamping members.

As shown at FIG. 20, the notches 300 preferably cut essentially completely through legs 602 of the flange engagement channel 638 to base portion 600 of the flange engagement channel 638. The cross sectional area of the band structure 623 at the notch locations (see FIG. 20) is preferably at least 50-80% of the transverse cross sectional area of the bolt 650. It will be appreciated that the band structure 623 is preferably designed so that the notched areas of the band structure 623 have sufficient cross sectional area to prevent failure during normal use. Therefore, depending upon the intended applications and tightening forces required, the cross sectional areas of the notched regions of the band structure 623 can vary from those specifically described herein.

It will be appreciated that the band structure 623 can be designed with cross sectional areas and thicknesses in accordance with those previously described in the application for other band structure embodiments described herein. Depending upon the application, other thicknesses than those specifically described can also be used.

Referring to FIG. 17, the band structure 623 is defined by two channel segments 636a, 636bthat are half circles with interior sides imposing one another to form the generally circular band. The channel segments 636a, 636bare joined at their upper ends by the fastening arrangement 639 and are joined at their lower ends by a connection piece 655. The connection piece 655 is depicted as a strap or other metal piece affixed, fastened or otherwise secured to the lower ends of the channel segments 636a, 636b. In certain embodiments, the connector piece 655 can function as a flexible hinge for facilitating flexing apart the upper ends of the band structure 623 to enlarge the diameter of the band structure 623 during installation. In other embodiments, the band structure 623 can have a one piece construction in which the connector piece 655 is replaced by a unitary/integral connection at the bottom of the band structure 623.

It will be appreciated that the two piece configuration of the band structure 623 has manufacturing advantages because the separate half pieces can more readily be manufactured using a die forming technique. In contrast, one-piece band structures would most likely by manufactured using other types of forming techniques such as roll forming.

FIG. 24 illustrates a further clamp 720 having features that are examples of inventive aspects in accordance with the principles of the present disclosure. Similar to the clamp of FIG. 17, the clamp 720 includes a band structure 723 having a fastening arrangement 739 positioned at a single circumferential location of the band structure 723. The depicted fastening arrangement 739 includes first and second non-threaded sleeves 752a, 752b secured to the ends of the band structure 723. The sleeves 752a, 752b non-threadably receive a fastener such as a bolt 750. The first and second sleeves 752a, 752b include seating surfaces 753a, 753b. When the clamp 720 is assembled, the head of the bolt 750 seats on the seating surface 753a, and a nut threaded upon the bolt 750 seats against the seating surface 752b. To eliminate the need to use two wrenches to tighten or loosen the fastening arrangement, the fastening arrangement preferably includes a structure for preventing the rotation of either the bolt 750 or the nut. For example, the bolt can have a noncircular (e.g., hex shaped) cross section that fits within a corresponding noncircular cross section of the first sleeve 752a. Alternatively, the nut can be welded or otherwise connected to the second sleeve 752b to prevent rotation of the nut during tightening. In other embodiments, internal threads can be provided within the second sleeve 752b to eliminate the need for a separate nut.

To further improve force distribution, in certain embodiments, the inner surfaces of the channel segment can be covered with an anti-friction coating such as molybdenum disulfide or other material for reducing the coefficient of friction of the channel segments.

To provide corrosion resistance (e.g., by preventing galvanization), the nut and the bolt can be made of different materials. For example, in one embodiment, one of the nut and the bolt can be made of stainless steel and the other of the nut and the bolt can be made of mild steel or plated steel (e.g., zinc plated steel).

From the forgoing detailed description, it will be evident that modifications and variations can be made in the devices of the disclosure without departing from the spirit or scope of the invention.

What is claimed is:

1. A clamp comprising:
a channel structure defining a circumference that generally encircles a center reference point, the channel structure having first ends that are drawn together for tightening the clamp, channel structure having a base portion and first and second legs that extend away from the base portion so as to define a generally v-shaped cross-section;
a first fastener for drawing the first ends of the channel structure together to tighten the clamp; and
the channel structure defining at least 6 flex regions spaced about the circumference of the channel structure, each flex region including a first notch defined within the first leg of the channel structure and a second notch defined within the second leg of the channel structure.

2. The clamp of claim 1, wherein at least 8 of the flex regions are provided about the circumference of the channel structure.

3. The clamp of claim 1, wherein at least 10 of the flex regions are provided about the circumference of the channel structure.

4. The clamp of claim 1, wherein the channel structure includes two half-circle segments.

5. The clamp of claim 4, wherein the channel structure includes second ends that are joined by a flexible hinge.

6. The clamp of claim 4, wherein the channel structure includes second ends, and wherein the clap includes a second fastener for drawing the second ends of the channel structure together to tighten the clamp.

7. The clamp of claim 1, further comprising first and second sleeves welded to channel structure adjacent the first ends of the channel structure, the first fastener being received within the first and second sleeves.

8. The clamp of claim 7, wherein the fastener includes a bolt, and wherein clamp further includes a nut into which the bolt threads.

9. The clamp of claim 8, wherein the nut is welded to one of the first and second sleeves.

10. The clamp of claim 1, wherein the fastener includes a bolt welded to the channel structure adjacent one of the first ends, and wherein the clamp includes a sleeve for receiving the bolt, the sleeve being welded to the other of the first ends of the channel structure.

11. The clamp of claim 1, wherein the first and second notches at each flex region extend completely through the first and second legs of the channel structure to the base portion of the channel structure.

12. A clamp comprising:
a channel structure defining a circumference that generally encircles a center reference point, the channel structure having first ends that are drawn together for tightening the clamp, channel structure having a base portion and first and second legs that extend away from the base portion so as to define a generally v-shaped cross-section;
a first fastener for drawing the first ends of the channel structure together to tighten the clamp; and
the channel structure defining notch regions spaced about the circumference of the channel structure, each notch region including a first notch defined within the first leg of the channel structure and a second notch defined within the second leg of the channel structure, wherein the notch regions divide the channel structure into at least 6 separate clamping elements.

13. The clamp of claim 12, wherein at least 8 of the separate clamping elements are provided about the circumference of the channel structure.

14. The clamp of claim 12, wherein at least 10 of the separate clamping elements are provided about the circumference of the channel structure.

15. A clamp comprising:
a channel structure defining a circumference that generally encircles a center reference point, the channel structure having ends that are drawn together for tightening the clamp, channel structure having a base portion and first and second legs that extend away from the base portion so as to define a generally v-shaped cross-section;
first and second sleeves welded to the channel structure adjacent the ends of the channel structure; and
a bolt for drawing the first ends of the channel structure together to tighten the clamp, the bolt being received in the first and second sleeves.

16. The clamp of claim 15, wherein the channel structure defining notch regions spaced about the circumference of the channel structure, each notch region including a first notch defined within the first leg of the channel structure and a second notch defined within the second leg of the channel structure, wherein the notch regions divide the channel structure into separate clamping elements, and wherein the channel structure includes at least 16 separate clamping elements.

17. The clamp of claim 15, wherein the channel structure includes two half-circle segments joined by a flexible hinge.

18. The clamp of claim 15, wherein clamp further includes a nut into which the bolt threads.

19. The clamp of claim 18, wherein the nut is welded to one of the first and second sleeves.

20. A clamp comprising:
a channel structure defining a circumference that generally encircles a center reference point, the channel structure having a base portion and first and second legs that extend away from the base portion so as to define a generally v-shaped cross-section, the channel structure including first, second and third channel segments;
a first fastener for drawing the first and second channel segments together to tighten the clamp;
a second fastener for drawing the second and third channel segments together to tighten the clamp; and
a third fastener for drawing the first and third channel segments together to tighten the clamp.
